(19) United States
(12) Patent Application Publication
(10) Pub. No.: US 2026/0023055 A1
(43) Pub. Date: Jan. 22, 2026

(54) DETECTOR FOR LIQUID CHROMATOGRAPH

(71) Applicant: SHIMADZU CORPORATION, Kyoto (JP)

(72) Inventor: Hiroyuki MINATO, Kyoto (JP)

(73) Assignee: SHIMADZU CORPORATION, Kyoto (JP)

(21) Appl. No.: 19/254,788

(22) Filed: Jun. 30, 2025

(30) Foreign Application Priority Data
Jul. 16, 2024 (JP) 2024-113110

(51) Int. Cl. G01N 30/74; G01N 30/02

(52) U.S. Cl. CPC G01N 30/74; G01N 2030/027

(57) ABSTRACT

A detector for a liquid chromatograph includes a flow cell (2) having an internal space (3; 3a; 3b) through which a liquid is passed, a light irradiation unit (4) including a light source (20) and configured to irradiate the flow cell (2) with light emitted from the light source (20), a light receiving unit (8) for receiving measurement light emitted from the flow cell (2), a camera (16) for imaging the internal space (3; 3a; 3b) of the flow cell (2), and a control unit configured to control an operation of the camera (16) to cause the camera (16) to perform imaging of the internal space (3; 3a; 3b) of the flow cell (2).

### BACKGROUND OF THE INVENTION

### Field of the Invention

The present invention relates to a detector for a liquid chromatograph.

### Description of the Related Art

Various types of detectors for liquid chromatographs exist, such as fluorescence detectors, spectrophotometric detectors, and differential refractive index detectors. Each of these detectors is provided with a flow cell, and by passing a sample liquid through an internal space of the flow cell while irradiating the flow cell with light, components in the sample liquid are detected and quantified by measuring the intensity of the light emitted from the flow cell or by measuring a change in an optical path length of the light emitted from the flow cell (see, for example, Patent Literature 1).

### PRIOR ART DOCUMENTS

### Patent Literature

[Patent Literature 1] Japanese Unexamined Patent Application Publication No. 2023-064637

### SUMMARY OF THE INVENTION

Bubbles may remain or debris may adhere inside a flow cell. Performing an analysis with bubbles or debris present inside the flow cell may adversely affect analysis accuracy, such as by causing instability in a baseline of a detector signal. Therefore, a solvent is passed through the inside of the flow cell so that bubbles and debris are discharged to the outside of the flow cell before starting an analysis, but in some cases, bubbles and debris remained even after such a process was performed.

To confirm the presence or absence of residual bubbles or debris inside the flow cell, methods such as removing the flow cell from the detector for visual confirmation (limited to cases where the flow cell is of a replaceable type), observing the baseline of the detector signal to confirm the magnitude of drift, and actually analyzing a known component to confirm whether an analysis result that should originally be obtained is obtained have been employed. However, any of these methods imposes a workload on a user and cannot be said to be an easy confirmation method for the user.

The present invention has been made in view of the above-described problems, and an object thereof is to enable easy confirmation of whether bubbles or debris remain inside a flow cell.

A detector for a liquid chromatograph according to the present invention includes a flow cell that has an internal space and through which a liquid is passed, a light irradiation unit that includes a light source and is configured to irradiate the flow cell with light emitted from the light source, a light receiving unit for receiving measurement light emitted from the flow cell, a camera for imaging the internal space of the flow cell, and a control unit that is configured to control an operation of the camera to cause the camera to perform imaging of the internal space of the flow cell.

According to the detector for a liquid chromatograph of the present invention, since the detector is provided with the camera for imaging the internal space of the flow cell, it is possible to acquire an image of the internal space of the flow cell and easily confirm whether bubbles or debris are present in the internal space of the flow cell.

### BRIEF DESCRIPTION OF THE DRAWINGS

FIG. 1 is a schematic configuration diagram illustrating an embodiment of a detector for a liquid chromatograph.

FIG. 2 is a diagram illustrating another example of an arrangement position of a camera.

FIG. 3 is a diagram illustrating an embodiment provided with a shutter for preventing stray light.

FIG. 4 is a diagram illustrating an example of an arrangement position of a camera when the detector for a liquid chromatograph is a differential refractive index detector.

### DETAILED DESCRIPTION OF THE PREFERRED EMBODIMENTS

Hereinafter, embodiments of a detector for a liquid chromatograph will be described with reference to the drawings.

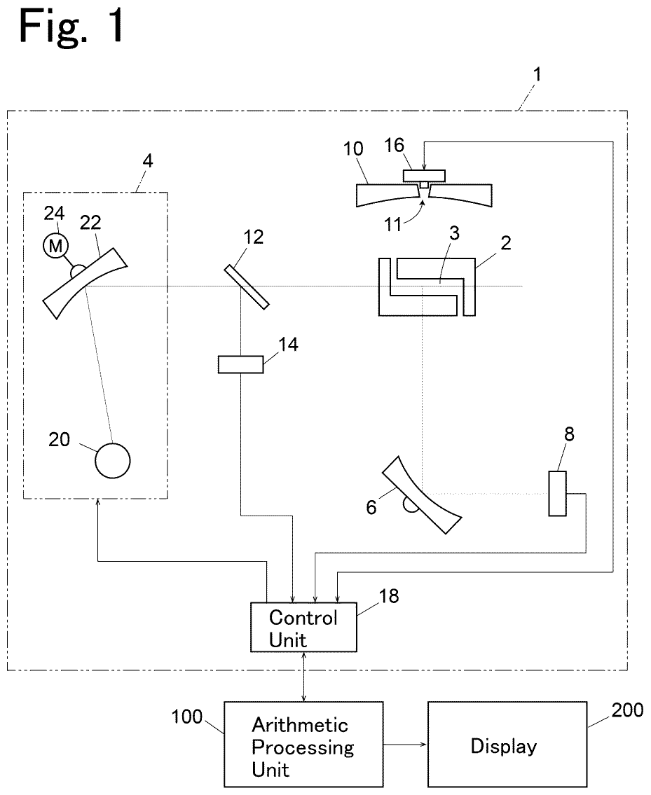

An embodiment of the detector for a liquid chromatograph is illustrated in FIG. 1.

A detector 1 includes a flow cell 2, a light irradiation unit 4, a diffraction grating 6, a measurement light receiving unit 8, a condensing mirror 10, a half mirror 12, a reference light receiving unit 14, a camera 16, and a control unit 18.

The flow cell 2 is made of a light-transmissive material and has an internal space 3 through which a sample liquid is passed. The light irradiation unit 4 includes a light source 20 and a diffraction grating 22, disperses light from the light source 20 with the diffraction grating 22, and irradiates the flow cell 2 with light of a wavelength component that serves as excitation light for exciting components in the sample liquid. The diffraction grating 22 is rotationally driven by a drive unit including a motor 24, so that a wavelength of the light with which the flow cell 2 is irradiated can be selectively changed.

The diffraction grating 6 disperses light emitted from the flow cell 2, and causes a fluorescence component emitted from a component excited by the excitation light in the flow cell 2 to enter the measurement light receiving unit 8 as measurement light. The measurement light receiving unit 8 is for detecting a fluorescence intensity guided from the diffraction grating 6, and is, for example, a photodiode.

A front surface of the condensing mirror 10 faces the flow cell 2 side, and the condensing mirror 10 reflects light emitted from the flow cell 2 at the front surface to guide the light to the diffraction grating 6. The camera 16 is disposed on a rear surface side of the condensing mirror 10, that is, on a side opposite to the flow cell 2 with the condensing mirror 10 interposed therebetween. A pinhole 11 is provided in a central portion of the condensing mirror 10, and the camera 16 can image the internal space 3 of the flow cell 2 via the pinhole 11.

The half mirror 12 is disposed on an optical axis of light traveling from the diffraction grating 22 to the flow cell 2, extracts a part of the light from the light irradiation unit 4 as reference light, and causes the reference light to enter the reference light receiving unit 14. The reference light receiving unit 14 is for detecting an intensity of the reference light from the half mirror 12, and is, for example, a photodiode.

The control unit 18 has a function of controlling operations of the light irradiation unit 4 and the camera 16, and causing the camera 16 to execute imaging of the internal space 3 of the flow cell 2 based on an instruction from a user or at a predetermined timing such as before an analysis is started.

The control unit 18 can use light from the light irradiation unit 4 as illumination for imaging when imaging the internal space 3 of the flow cell 2 with the camera 16. Alternatively, an imaging light source may be provided separately from the light irradiation unit 4, and the control unit 18 may turn on the light source during imaging by the camera 16. When the light from the light irradiation unit 4 is used as illumination for imaging, the light with which the light irradiation unit 4 irradiates the flow cell 2 is not particularly limited as long as it illuminates the internal space 3, but by irradiating the flow cell 2 with zero-order diffracted light from the diffraction grating 22, the flow cell 2 can be most brightly illuminated, and a clear image or video can be acquired by the camera 16.

The control unit 18 takes in an image or video of the internal space 3 of the flow cell 2 acquired by the camera 16, and the control unit 18 outputs the image or video to an arithmetic processing unit 100 connected to be capable of mutual communication with the detector 1. A display 200 is connected to the arithmetic processing unit 100 to be capable of communication, and the image or video of the internal space 3 of the flow cell 2 acquired by the camera 16 is displayed on the display 200. This allows the user to easily confirm whether bubbles or debris are present in the internal space 3 of the flow cell 2.

Note that it is not essential to display the image or video acquired by the camera 16 on the display 200. The control unit 18 or the arithmetic processing unit 100 may be configured to automatically recognize from the image or video acquired by the camera 16 whether bubbles or debris are present in the internal space 3 of the flow cell 2, and to take measures such as issuing a warning when bubbles or debris are present in the internal space 3 of the flow cell 2.

Here, the control unit 18 can be realized by, for example, an electronic circuit board including a CPU (Central Processing Unit) and an information storage device. The arithmetic processing unit 100 can be realized by a computer device such as a personal computer.

The control unit 18 also, at the time of measurement, takes in a fluorescence intensity detected by the measurement light receiving unit 8 and a reference light intensity detected by the reference light receiving unit 14 at regular time intervals, and outputs signals corresponding to the fluorescence intensity and the reference light intensity to the arithmetic processing unit 100. In the arithmetic processing unit 100, detection and quantification of components in the sample liquid flowing through the internal space 3 of the flow cell 2 are performed using the signals corresponding to the fluorescence intensity and the reference light intensity from the control unit 18.

Since the detector 1 of this embodiment is a fluorescence detector in which the condensing lens 10 is disposed in the vicinity of the flow cell 2, by providing the pinhole 11 in the condensing lens 10, the camera 16 can be disposed behind the condensing lens 10, whereby it is possible to suppress light reflected by the camera 16 during analysis from becoming stray light and entering the light receiving unit 8 and/or 14.

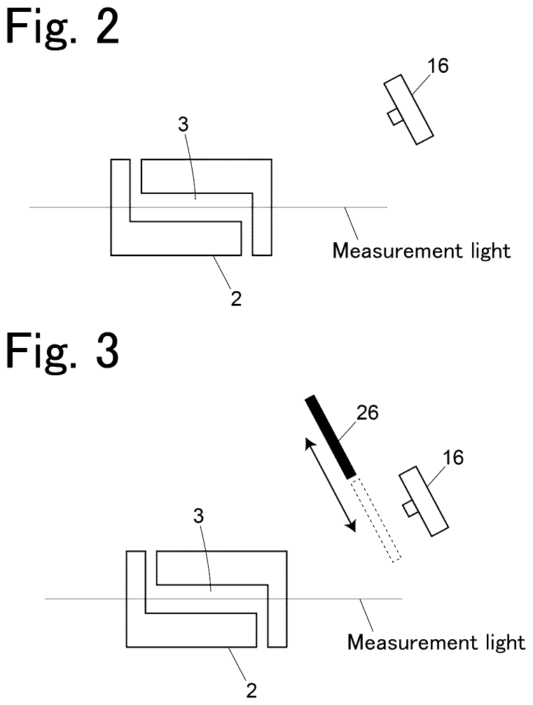

On the other hand, the present invention is not limited to the detector having the above-described configuration, and can be applied to various detectors other than the fluorescence detector. As illustrated in FIG. 2, the position of the camera 16 may be any position as long as it can image the internal space 3 of the flow cell 2 and does not affect the analysis. Note that when light is reflected by the camera 16 and stray light is generated, as illustrated in FIG. 3, a shutter 26 that opens and closes in front of the camera 16 may be provided, the shutter 26 may be closed to shield a front side of the camera 16 during analysis, and the shutter 26 may be opened when the internal space 3 of the flow cell 2 is imaged by the camera 16.

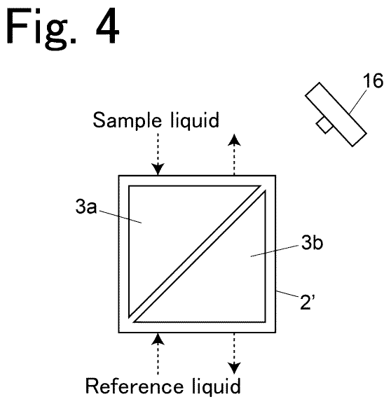

Furthermore, when the present invention is applied to a differential refractive index detector, as illustrated in FIG. 4, the flow cell 2′ has a structure in which an internal space 3a through which a sample liquid is passed and an internal space 3b through which a reference liquid is passed are disposed with a transparent partition wall interposed therebetween. In this case, as illustrated in the same figure, it is desirable that the camera 16 is disposed at a position where both the internal spaces 3a and 3b can be imaged simultaneously. Note that the present invention is not limited to this, and a camera for imaging the internal space 3a of the flow cell 2′ and a camera for imaging the internal space 3b may be provided separately, or one camera may be moved to image the internal spaces 3a and 3b, respectively.

The embodiments described above are merely examples of the embodiments of the detector for a liquid chromatograph according to the present invention. The embodiments of the detector for a liquid chromatograph according to the present invention are as follows.

In one embodiment of the detector for a liquid chromatograph according to the present invention, the detector includes a flow cell that has an internal space and through which a liquid is passed, a light irradiation unit that includes a light source and is configured to irradiate the flow cell with light emitted from the light source, a light receiving unit for receiving measurement light emitted from the flow cell, a camera for imaging the internal space of the flow cell, and a control unit that is configured to control an operation of the camera to cause the camera to perform imaging of the internal space of the flow cell.

In a first aspect of the one embodiment, the detector further includes an optical element that has a front surface and a rear surface and is provided in the vicinity of the flow cell with the front surface facing the flow cell, wherein a pinhole extending from the front surface to the rear surface is provided in the optical element, and the camera is provided so as to image the internal space of the flow cell via the pinhole from a position on a side opposite to the flow cell with the optical element interposed therebetween. According to this first aspect, since the camera is hidden behind the optical element, reflection of light by the camera during analysis, which would become stray light, is suppressed.

In the first aspect, the optical element may be a condensing lens for condensing light emitted from the flow cell.

Furthermore, in a second aspect of the one embodiment, the control unit is configured to control the light irradiation unit and to perform imaging of the internal space of the flow cell in a state where the flow cell is irradiated with light from the light irradiation unit. According to this second aspect, it is not necessary to provide a dedicated light source for imaging the flow cell by the camera. This second aspect can be combined with the first aspect.

As an example of a preferable mode of the second aspect, a mode is cited in which the light irradiation unit includes a diffraction grating that disperses light from the light source, and a drive unit that rotates the diffraction grating to direct light of a desired wavelength toward the flow cell, and the control unit is configured to perform imaging of the internal space of the flow cell in a state where the flow cell is irradiated with zero-order diffracted light from the diffraction grating. According to such a mode, since strong light can be irradiated from the light irradiation unit during imaging of the flow cell by the camera, a clear image or video of the internal space of the flow cell can be acquired by the camera.

Furthermore, in a third aspect of the one embodiment, the control unit is configured to output an image or video of the internal space of the flow cell acquired by the camera to a display communicably connected to the detector for a liquid chromatograph. According to this third aspect, since the image or video of the internal space of the flow cell is displayed on the display, a user can easily confirm whether bubbles or debris are present in the internal space of the flow cell.

### REFERENCE SIGNS LIST

1 Detector for liquid chromatograph
2, 2′ Flow cell
3, 3a, 3b Internal space
4 Light irradiation unit
6, 22 Diffraction grating
8 Measurement light receiving unit
10 Condensing lens
12 Half mirror
14 Reference light receiving unit
16 Camera
18 Control unit
20 Light source
24 Motor
26 Shutter
100 Arithmetic processing unit
200 Display

1. A detector for a liquid chromatograph, comprising:
a flow cell having an internal space through which a liquid is passed;
a light irradiation unit including a light source and configured to irradiate the flow cell with light emitted from the light source;
a light receiving unit for receiving measurement light emitted from the flow cell;
a camera for imaging the internal space of the flow cell; and
a control unit configured to control an operation of the camera to cause the camera to perform imaging of the internal space of the flow cell.

2. The detector for a liquid chromatograph according to claim 1, further comprising:
an optical element having a front surface and a rear surface, and provided in a vicinity of the flow cell with the front surface facing the flow cell,
wherein the optical element is provided with a pinhole extending from the front surface to the rear surface, and
the camera is provided so as to image the internal space of the flow cell via the pinhole from a position on a side opposite to the flow cell with the optical element interposed therebetween.

3. The detector for a liquid chromatograph according to claim 2, wherein the optical element is a condensing lens for condensing light emitted from the flow cell.

4. The detector for a liquid chromatograph according to claim 1, wherein the control unit is configured to control the light irradiation unit and to perform imaging of the internal space of the flow cell in a state where the flow cell is irradiated with light from the light irradiation unit.

5. The detector for a liquid chromatograph according to claim 4, wherein the light irradiation unit includes a diffraction grating that disperses light from the light source, and a drive unit that rotates the diffraction grating to direct light of a desired wavelength toward the flow cell, and the control unit is configured to perform imaging of the internal space of the flow cell in a state where the flow cell is irradiated with zero-order diffracted light from the diffraction grating.

6. The detector for a liquid chromatograph according to claim 1, wherein the control unit is configured to output an image or video of the internal space of the flow cell acquired by the camera to a display communicably connected to the detector for a liquid chromatograph.
